(19) United States
(12) Patent Application Publication
(10) Pub. No.: US 2025/0308325 A1
(43) Pub. Date: Oct. 2, 2025

(54) SYSTEMS AND METHODS FOR PREDICTING THE OUTCOME OF AN EVENT

(71) Applicant: Anthony Francesco Aiello, Toronto (CA)

(72) Inventor: Anthony Francesco Aiello, Toronto (CA)

(21) Appl. No.: 19/097,780

(22) Filed: Apr. 1, 2025

Related U.S. Application Data
(60) Provisional application No. 63/573,042, filed on Apr. 2, 2024.

(30) Foreign Application Priority Data
Apr. 2, 2024 (CA) 3234021

(51) Int. Cl. G07F 17/32; A63B 71/06; G06Q 50/34

(52) U.S. Cl. CPC G07F 17/323; A63B 71/06; G06Q 50/34; G07F 17/3288

(57) ABSTRACT

Various embodiments for predicting an outcome of a sporting event are disclosed herein. The embodiments disclosed involve: storing a plurality of data related to the sporting event in a database; and receiving, by a processor, a prediction request, wherein each prediction request comprises a home team selection, and an away team selection relating to the sporting event. For each prediction request, determining, by the processor, one or more damage factors relating to the chosen home team and away team; calculating, by the processor, an implied probability score based on the damage factors for the chosen home team and away team; determining, by the processor, an outcome prediction and a betting line recommendation based on the implied probability score; and transmitting, by the processor, the outcome prediction and the betting line recommendation to a user device associated with the prediction request.

### FIELD

The embodiments described herein generally relate to systems and methods for determining and/or predicting the outcome of an event using statistical analysis. The embodiments described herein more specifically relate to determining and/or predicting the outcome of a sporting event or game including but not limited to hockey games, basketball games, baseball games and the like.

### BACKGROUND

The following is not an admission that anything discussed below is part of the prior art or part of the common general knowledge of a person skilled in the art.

The analysis of sports data serves to gauge player and team performance and forecast future game outcomes. These predictions are crucial for fan engagement and play a significant role in the sports betting industry. Prior methods have often focused on predicting individual player performance or game outcomes without fully considering contextual factors. Some approaches have concentrated on win probabilities and scoring chances during a game, while others have used statistical models to estimate player ratings and expected goals. Additionally, methods have been devised to evaluate individual events within a game, such as the likelihood of a shot resulting in a goal, which provides prediction for individual events within a game, but not the complete game.

It is an objective to overcome at least one of the above-noted shortcomings of prior methods.

### SUMMARY

This summary is intended to introduce the reader to the more detailed description that follows and not to limit or define any claimed or yet unclaimed invention. One or more inventions may reside in any combination or sub-combination of the elements or process steps disclosed in any part of this document including its claims and figures.

In a first aspect, in at least embodiment, there is provided a system for predicting an outcome of a sporting event. The system comprises a database for storing a plurality of data related to the sporting event; and a processor in communication with the database. The processor can be operable to: receive a prediction request, wherein each prediction request comprises a home team selection, and an away team selection relating to the sporting event. For each prediction request, the processor can be operable to: determine one or more damage factors relating to the chosen home team and away team; calculate an implied probability score based on the damage factors for the chosen home team and away team; determine an outcome prediction and a betting line recommendation based on the implied probability score; and transmit the outcome prediction and the betting line recommendation to a user device associated with the prediction request. The outcome prediction can include an indication of the home team or the away team winning the sporting event; and the betting line recommendation can include odds of the home team or the away team winning the sporting event.

In some embodiments, the processor is further operable to receive a consecutive game indication indicating that the sporting event is being played consecutively by a home team or an away team. In some embodiments, the processor is further operable to receive a recent wins indication indicating that at least one of the home team and the away team has recently won at least one of a plurality of past sporting events.

In some embodiments, the plurality of data comprises at least one of: team statistics, player statistics, goalie statistics, recent win statistics, and player injury statistics. In some embodiments, the database is sourced in real-time, or near real-time. In some embodiments, the database is updated at least one of: hourly, daily, weekly, monthly, once the sporting event is completed, and as the sporting event is on-going. In some embodiments, the data is stored as at least one of: CSV files, key value pairs, row/column store, JSON, XML, and Parquet files. In some embodiments, calculating an implied probability score is based on the damage factors for the chosen home team and away team; and comprises leveraging at least one of a plurality of statistics with predetermined weightages to influence the outcome prediction.

In some embodiments, the plurality of statistics comprises at least one of: CF % (Corsi For Percentage); xGA (Expected Goals Against) and xGF % (Expected Goals For Percentage); HDCF % and HDSF %; PDO; GSAA (Goals Saved Above Average); and xGF % for forwards and xCF % for defensemen. In some embodiments, the damage factor is proportional to at least one of: recent losses, away team disadvantage, playing of consecutive games, roster of players, player statistics, team statistics, goalie statistics, and player injuries.

In some embodiments, the processor is further operable to determine one or more advantage factors relating to the chosen home team and away team. In some embodiments, the advantage factor is proportional to at least one of: recent wins, home team advantage, lack of consecutive games, roster of players, player statistics, team statistics, goalie statistics, and lack of injuries. In some embodiments, the damage factor can be inversely related to the advantage factor.

In accordance with another aspect, in at least one embodiment, there is provided a method for predicting an outcome of a sporting event. The method comprises storing a plurality of data related to the sporting event in a database; and receiving, by a processor, a prediction request, wherein each prediction request comprises a home team selection, and an away team selection relating to the sporting event. The method further comprises, for each prediction request, determining, by the processor, one or more damage factors relating to the chosen home team and away team; calculating, by the processor, an implied probability score based on the damage factors for the chosen home team and away team; determining, by the processor, an outcome prediction and a betting line recommendation based on the implied probability score; and transmitting, by the processor, the outcome prediction and the betting line recommendation to a user device associated with the prediction request. The outcome prediction can include an indication of the home team or the away team winning the sporting event; and the betting line recommendation can include odds of the home team or the away team winning the sporting event.

In some embodiments, the method further comprises updating the database in real-time, or near real-time. In some embodiments, the method further comprises updating the database least one of: hourly, daily, weekly, monthly, once the sporting event is completed, and as the sporting event is on-going.

In some embodiments, the method further comprises calculating an implied probability score based on the damage factors for the chosen home team and away team comprises leveraging at least one of a plurality of statistics with predetermined weightages to influence the outcome prediction. In some embodiments, the plurality of statistics comprises at least one of: CF % (Corsi For Percentage); xGA (Expected Goals Against) and xGF % (Expected Goals For Percentage); HDCF % and HDSF %; PDO; GSAA (Goals Saved Above Average); and xGF % for forwards and xCF % for defensemen.

In some embodiments, the damage factor is proportional to at least one of: recent losses, away team disadvantage, playing of consecutive games, roster of players, player statistics, team statistics, goalie statistics, and player injuries. In some embodiments, the method further comprises operating the processor to determine one or more advantage factors relating to the chosen home team and away team. In some embodiments, the advantage factor is proportional to at least one of: recent wins, home team advantage, lack of consecutive games, roster of players, player statistics, team statistics, goalie statistics, and lack of injuries.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the example outcome prediction system of FIG. 1 in communication with external components;

FIG. 2 is a flowchart of an example method for predicting an outcome of an event in accordance with an embodiment;

FIG. 3 is a process flow diagram of an example method of collecting and storing data by the outcome prediction system of FIG. 1;

FIG. 4 is a process flow diagram of an example method of predicting an outcome of an event determined by the outcome prediction system of FIG. 1;

FIG. 5 is a process flow diagram of an example method of predicting an outcome of an event determined by the outcome prediction system of FIG. 1;

FIG. 6 is a process flow diagram of an example method of obtaining user inputs by the outcome prediction system of FIG. 1;

FIG. 7 is a process flow diagram of an example method of obtaining user decisions by the outcome prediction system of FIG. 1;

FIG. 8 is a process flow diagram of example inputs into outcome prediction system of FIG. 1;

FIG. 9 is a process flow diagram of an example method of predicting an outcome of an event determined by the outcome prediction system of FIG. 1;

FIG. 10 is an example GUI showing the outcome prediction system of FIG. 1 on a user device in accordance with an embodiment;

FIG. 11 is an example GUI showing the outcome prediction system of FIG. 1 on a user device in accordance with an embodiment;

FIG. 12 is an example GUI showing the outcome prediction system of FIG. 1 on a user device in accordance with an embodiment;

FIG. 13 is an example GUI showing the outcome prediction system of FIG. 1 on a user device in accordance with an embodiment;

FIG. 14 is an example GUI showing the outcome prediction system of FIG. 1 on a user device in accordance with an embodiment;

FIG. 15 is an example GUI showing the outcome prediction system of FIG. 1 on a user device in accordance with an embodiment;

FIG. 16A is an example GUI showing the outcome prediction system of FIG. 1 on a user device in accordance with an embodiment;

FIG. 16B is an example GUI showing the outcome prediction system of FIG. 1 on a user device in accordance with an embodiment;

FIG. 17 is an example GUI showing the outcome prediction system of FIG. 1 on a user device in accordance with an embodiment;

FIG. 18 is an example GUI showing the outcome prediction system of FIG. 1 on a user device in accordance with an embodiment; and

FIG. 19 is an example GUI showing the outcome prediction system of FIG. 1 on a user device in accordance with an embodiment.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures, and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more elements are said to be “coupled”, “connected”, “attached”, or “fastened” where the parts are joined or operate together either directly or indirectly (i.e., through one or more intermediate parts), so long as a link occurs. As used herein and in the claims, two or more elements are said to be “directly coupled”, “directly connected”, “directly attached”, or “directly fastened” where the element are connected in physical contact with each other. None of the terms “coupled”, “connected”, “attached”, and “fastened” distinguish the manner in which two or more elements are joined together.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

In the evolving field of sports analytics, existing models have made significant strides in predicting game outcomes by leveraging historical data and advanced statistical techniques. However, there appear to be inherent limitations in these models, particularly regarding the integration of real-time data, the depth of contextual analysis, and the provision for user-driven customization. This gap underscores the necessity for an innovative approach that not only harnesses the power of comprehensive data analytics but also addresses the dynamic nature of sports events, the nuanced interplay of various game factors, and the specific needs of users seeking to make informed predictions.

One such limitation is the over-reliance on basic statistics and lack of contextual factors integration. The existing systems primarily focus on processing game data, including historical data and AI techniques to model team sports dynamics for game outcome prediction. However, they may not fully account for the depth of contextual factors mentioned in greater detail below, such as team fatigue from back-to-back games, psychological aspects like recent wins or losing streaks, home advantage, and specific in-game strategies.

For example, psychological aspects such as recent wins or losing streaks can affect team morale and confidence, and such are pivotal. Teams on a winning streak may carry momentum that boosts performance, while those on a losing streak might struggle with morale, affecting gameplay.

In another example, home advantage can also have an impact on the outcome of a game. Playing a game on home territory can provide a significant boost to teams, influenced by factors like crowd support and familiarity with the playing environment. Models that do not account for home advantage may miss crucial nuances in predicting game outcomes.

In another example, in-game strategies can also have an impact on the outcome of a game. For example, the strategic decisions made by coaches, such as line changes and defensive strategies, play a critical role in the game's flow and outcome. Models that fail to consider these tactical aspects may overlook key elements that could sway the game in favour of one team.

In another example, the lack of real-time data integration can also have an impact on the outcome prediction of a game. It may be beneficial to integrate comprehensive real-time data such as day-to-day roster changes and injury information, crucial for the fluid and unpredictable nature of sports, particularly hockey. This limitation primarily pertains to the model's potential gap in fully incorporating day-to-day roster changes and up-to-the-minute injury reports. For example, in hockey, like many team sports, is highly dynamic, with team compositions and player availability frequently changing due to injuries, tactical decisions, or other factors. The effectiveness of predictive models in such an environment hinges on their ability to adapt to these changes in real-time.

A model that relies heavily on visual and trajectory data may not capture the full extent of these critical factors unless it is explicitly designed to integrate additional real-time data sources that reflect the current state of team rosters and player health. For instance, the sudden absence of a key player due to a last-minute injury, a healthy scratch due to the head coach's decision, or a strategic lineup change can significantly alter the course of a game, affecting team strategies, player roles, and ultimately, the game outcome. Current models focusing on visual and trajectory data might not account for these changes adequately if they do not seamlessly integrate real-time updates on player availability and team compositions. This integration is crucial for maintaining the accuracy and relevance of predictions, especially in a fast-paced sport where such variables can have a profound impact on the dynamics of the game. Therefore, day-to-day roster changes and injury information, improve the predictive accuracy and operational relevance of the system. This enhancement would ensure that predictions remain reflective of the live conditions and the ever-changing landscape of team sports, providing users with insights that are as current and informative as possible.

Additionally, there is a noted gap in allowing users to customize inputs based on their own unique observations or preferences. This personalization aspect is crucial for users who wish to adjust predictions based on factors they consider relevant, such as emphasizing the impact of a star or key player being injured or a star or key player returning from an injury. Specifically, prior art/current models often lack a crucial element of user customization, particularly in the context of integrating nuanced, real-time knowledge about player conditions into their predictive algorithms. This absence of personalization limits the models' ability to accurately reflect the dynamic nature of sports games, where external environmental factors and undisclosed injuries can significantly impact outcomes.

One limitation is the inability of these models to account for a user's specific insight into the condition and potential impact of star or key player. Consider a scenario where a user, drawing on their understanding of the game and the players involved, assesses that a star or key player's absence due to a minor, undisclosed injury is unlikely to detrimentally affect the team's performance. This assessment could stem from a belief that the star player, despite their high profile, might actually be overrated, with their contributions being more a product of fortunate circumstances than a consistently significant impact on the game. Alternatively, the user may recognize that the team has previously demonstrated resilience and adaptability in similar situations, effectively mitigating the absence of key players through strategic gameplay and the strength of the supporting roster. Conversely, there may be instances where a user has reasons to believe that a star or key player, despite participating in the game, is playing with an undisclosed injury that could hamper their performance. This is particularly relevant in high-stakes scenarios, such as a decisive game in the NHL® Stanley Cup finals, where a player might choose to play through pain rather than miss a critical match. The team might also conceal this injury to avoid giving a tactical advantage to the opponents. Current predictive models lack the ability to incorporate this nuanced user knowledge into their calculations, possibly underestimating the injury's impact on the team's performance.

Current predictive models, however, often lack the flexibility to incorporate this level of user insight into their algorithms. They are typically designed to automatically adjust predictions based on the presence or absence of key players due to injuries, without the ability for users to override these adjustments based on personal analysis or intuition about the player's actual impact on the team's performance. This can lead to predictions that might overestimate the negative impact of a star or key player's injury, not considering the user's belief in the player's overrated influence or the team's capacity for adaptation. This gap highlights the need for predictive models in sports analytics to offer greater personalization, allowing users to apply their unique insights and judgments about players and teams. By enabling users to decide whether or not to include a star or key player's injury in the model based on a deeper understanding of the player's true value and the team's dynamics, predictive analytics can become more aligned with the nuanced realities of sports competitions.

Furthermore, existing systems rely on historical and hypothetical analyses to predict game outcome, typically ignoring real-time data and in-depth contextual factors like live player injuries, team morale, and tactical shifts. This limitation underscores a crucial area for development, highlighting the necessity to intertwine real-time event data comprehensively to refine prediction accuracy and relevance effectively.

Some systems employ deep neural networks for sports event prediction, leveraging extensive historical data for outcome generation. Despite its technological advancement, the model's structure might not sufficiently accommodate sudden game developments or fluctuating player performances, which are integral to the unpredictable nature of sports. This shortfall signals an essential need for incorporating flexible algorithms within predictive models, ones capable of adapting to the live dynamics of a game, thereby offering predictions that mirror real-time scenarios more accurately.

In another example, the reliance on past events over present realities can also have an impact on the outcome prediction of a game. While some systems provide an analytical approach for estimating win probabilities, the existing systems predominantly rest only on historical data, potentially underestimating the impact of immediate game conditions, player health, and team strategies. This reliance emphasizes the challenge of integrating contemporaneous factors into predictive models, an advancement that would significantly enhance the precision and adaptability of sports predictions in reflecting the dynamism of live games.

In the dynamic intersection of sports analytics and the ever-expanding field of legal online sports betting globally, a discernible gap in existing predictive models becomes increasingly apparent. While these models proficiently predict game outcomes using historical data and advanced statistical techniques, they notably lack the integration of sports betting line recommendations. This absence overlooks the growing importance of providing bettors with not just predictions on which team might win or lose, but actionable insights into betting lines that could optimize their potential returns.

As sports betting gains legal footing and societal acceptance, the demand for predictive models that keep pace with this evolution is undeniable. Bettors are not only looking for which team to select, but also seek nuanced advice on how to navigate betting spreads, money lines, and over/unders to make informed decisions. The current landscape of predictive sports models, however, remains largely disconnected from these needs, focusing more on game dynamics rather than the strategic aspects of betting that could significantly influence a bettor's approach and outcomes.

This oversight highlights a critical opportunity for innovation within sports analytics. By integrating betting line recommendations that reflect real-time game probabilities and adjust to market dynamics, predictive models could vastly enhance their relevance and utility in a rapidly expanding betting market. Such a feature would not merely extend the functionality of predictive models beyond traditional outcome forecasting but would also align them with the realities of a legal sports betting environment that demands a deeper level of analysis and strategic insight.

Therefore, the evolution of predictive sports models to include sports betting line recommendations represents a vital step forward. It acknowledges the complexity and nuance of modern sports betting, catering to a more informed and strategic user base. By bridging this gap, predictive models can offer a more holistic and valuable tool for bettors, marrying the predictive accuracy of sports outcomes with the strategic acumen required in sports betting. This integration not only enhances the applicability of sports analytics in the burgeoning betting landscape but also signifies a proactive adaptation to the changing legal and cultural acceptance of sports betting in North America.

In the ever-growing domain of sports analytics, the journey toward perfecting game outcome predictions has been marked by significant technological strides, yet there are still challenges with the existing systems. Central among these challenges is a perceivable deficit in the integration of real-time data and a comprehensive contextual analysis-crucial elements that elevate the predictive accuracy to mirror the dynamic essence of sports events more faithfully.

The outcome prediction system taught herein offers an interface where users can influence predictions by selecting team matchups, starting goalies, and highlighting injured players. The system can utilize user inputs with real-time data from a databank to calculate and determine the outcome prediction of a game such as a sporting game.

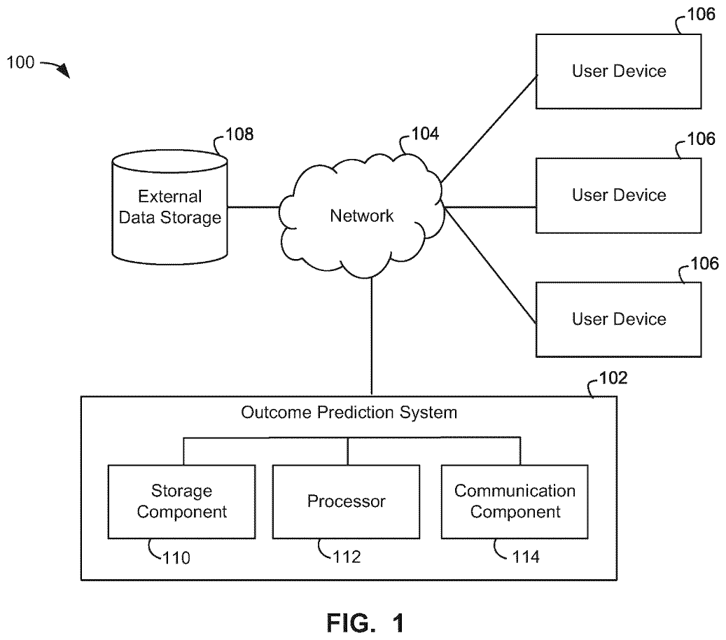

Reference is first made to FIG. 1, which shows a block diagram 100 of an outcome prediction system 102 in communication with a user device 106 via a network 104. The outcome prediction system 102 receives prediction requests from a user accessing a user device 106, and wanting to determine an outcome prediction for an event such as a sporting event or game. The outcome prediction system 102, via a processor 112, can calculate or determine the probability of a specific team winning a game, and provide a calculated betting line output to the user via the user device 106.

The network 104 may be any network that allows the outcome prediction system 102 to communicate with the provider 106. The network 104 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the outcome prediction system 102 and the provider 106.

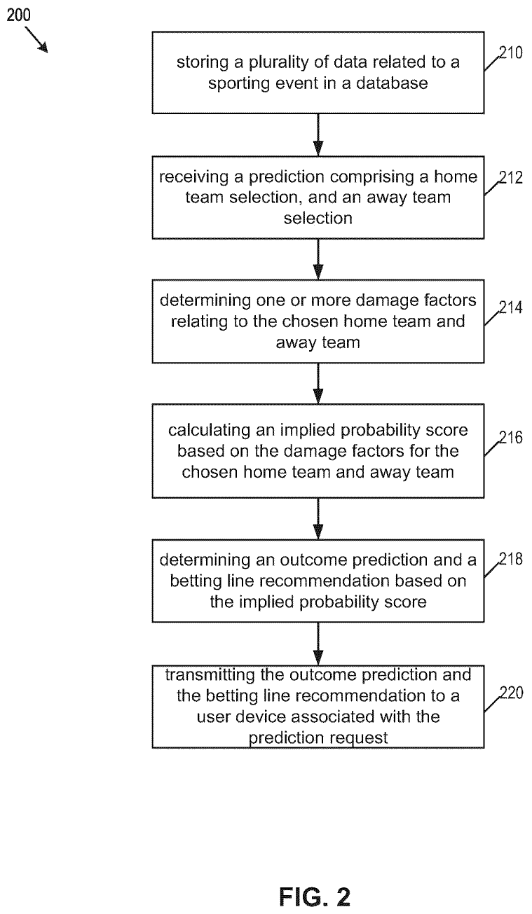

FIG. 1 also shows a block diagram of the outcome prediction system 102, in communication with an external data storage 108 and user devices 106, via a network 104. While FIG. 2 shows three user devices 106, it will be understood that the outcome prediction system 102 may be in communication with at least one user device, and may be in communication with a greater number of user devices. The outcome prediction system 102 can communicate with the user devices 106 over a wide geographic area via the network 104.

The outcome prediction system 102 includes a storage component 110, a processor 112 and a communication component 114. The outcome prediction system 102 can be implemented with more than one computer server distributed over a wide geographic area and connected via the network 104 and may be provided using various computing such as, for example, an electronic tablet device, a personal computer, workstation, server, portable computer, mobile device, personal digital assistant, laptop, smart phone, WAP phone, an interactive television, video display terminals, gaming consoles, and portable electronic devices etc. The storage component 110, the processor 112 and the communication component 114 may be combined into a fewer number of components or may be separated into further components.

The processor 112 can be implemented with any suitable processors, controllers, digital signal processors, application specific integrated circuits (ASICs), and/or field programmable gate arrays (FPGAs) that can provide sufficient processing power depending on the configuration, purposes and requirements of the outcome prediction system 102. In some embodiments, the processor 112 can include more than one processor with each processor 112 being configured to perform different dedicated tasks.

The processor 112 can be configured to control the operation of the outcome prediction system 102. For example, the processor 112 can receive event outcome prediction requests and provide an outcome for the events. The processor 112 can also be configured to control communications between the outcome prediction system 112, the external data storage 108 and the user devices 106.

The communication component 114 may be any component that enables the outcome prediction system 102 to communicate with other devices and systems, such as, but not limited to, the user devices 106 and the external data storage 108. For example, the communication component can receive the prediction requests that may then be transmitted to the processor 112 and can transmit the outcome to the user devices 106. In some embodiments, the communication component 114 can include at least one of a serial port, a parallel port or a USB port. The communication interface 114 may also include at least one of an Internet, Local Area Network (LAN), Ethernet, Firewire, modem or digital subscriber line connection. In some embodiments, the communication component 114 may be a wireless communication interface, which can transmit various data to other devices or systems via Bluetooth, WiFi, or other suitable wireless communication standard. Various combinations of these elements may be incorporated within the communication component 114. For example, the communication component 114 may receive input from various input devices, such as a mouse, a keyboard, a touch screen, a thumbwheel, a trackpad, a track-ball, a card-reader, voice recognition software and the like depending on the requirements and implementation of the outcome prediction system 102.

The storage component 110 can include RAM, ROM, one or more hard drives, one or more flash drives or some other suitable data storage elements such as disk drives, etc. The storage component 110 can include one or more databases for storing data, such as, but not limited to data relating to statistics and data relating to games and teams, profiles, including data related to team statistics, recent win statistics, player statistics, goalie statistics, player injuries statistics, user preferences and user attributes. The storage component 110 can additionally store algorithms and computer-executable instructions that can be executed by the processor 112 to determine game outcome.

The external data storage 108 can store data similar to that of the storage component 110. The external data storage 108 can, in some embodiments, be used to store data that is less frequently used and/or older data. In some embodiments, the external data storage 108 can be a third-party data storage stored with input data for analysis by the outcome prediction system 102. The data stored in the external data storage 108 can be retrieved by the outcome prediction system 102 via the network 104.

Each user device 106 can be any device capable of communicating with other devices through a network such as the network 104. Each user device 106 can couple to the network 104 through a wired or wireless connection. Each user device 106 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

Each user device 106 can be associated with a user of the outcome prediction system 102, such as, for example, an individual or entity requesting an outcome of a game, and can be configured to receive the outcome predictions. In some embodiments, the user devices 106 can transmit prediction requests to the outcome prediction system 102. In some embodiments, some user devices 106 can be referral user devices and can be associated with entities or individuals requesting or referring an outcome prediction on behalf of the individual receiving the outcome. In such embodiments, the outcome prediction system 102 can receive outcome prediction requests from referral user devices and can transmit the determined outcome to user devices 106 associated with the individual making the request. The referral user devices can include automated requests from bots, other applications via an API, or from other individuals or entities.

The network 104 may be substantially similar to the network 104 and can be capable of interfacing with, and enabling communication between, the outcome prediction system 102, the user devices 106 and the external data storage 108.

Referring now to FIG. 2, there is shown a flowchart of an example method 200 of predicting an outcome of a sporting event. In at least one embodiment, the method comprises: storing a plurality of data related to a sporting event in a database at 210; receiving a prediction comprising a home team selection, and an away team selection at 212; determining one or more damage factors relating to the chosen home team and away team at 214; calculating an implied probability score based on the damage factors for the chosen home team and away team at 216; determining an outcome prediction and a betting line recommendation based on the implied probability score at 218; and transmitting the outcome prediction and the betting line recommendation to a user device associated with the prediction request at 220.

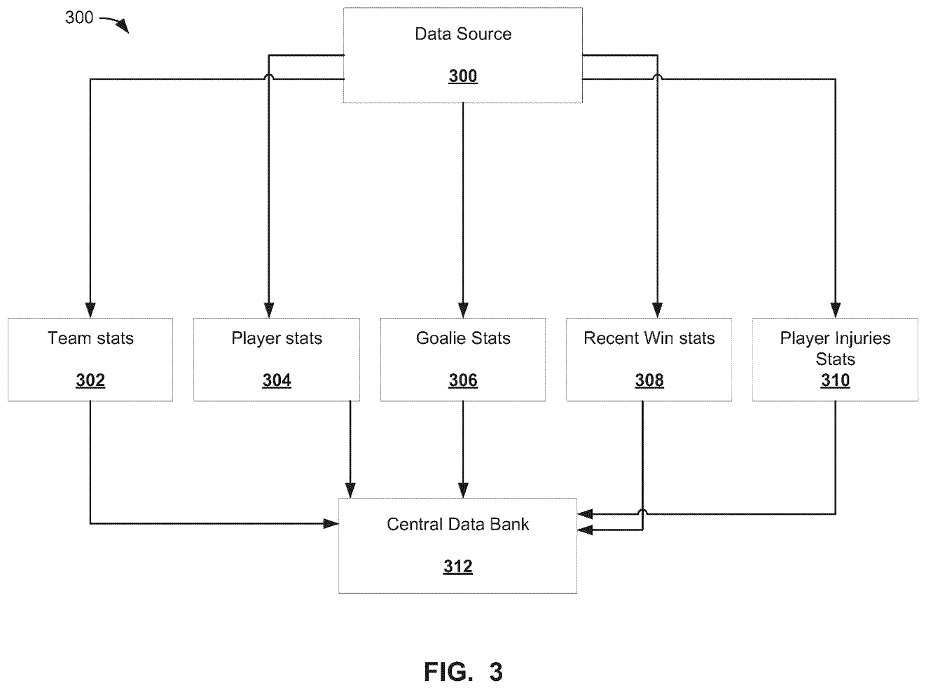

Referring now to FIG. 3, there is shown a process flow diagram of an example method of collecting and storing data by the outcome prediction system 102. Data such as team statistics 302, player statistics 304, goalie statistics 306, recent win statistics 308, and player injury statistics 310 can be collected or retrieved from a data source 300. The data source 300 can include: sports databases, league databases, historical data, recordings of past games, and any other suitable source of data. Specifically, the data source 300 can be multifaceted, drawing from a variety of repositories to ensure a holistic view of the sporting landscape. Specifically, the data being sourced can include player and team statistics, which include critical metrics such as Corsi For Percentage (CF %), Expected Goals Against (xGA), Expected Goals For Percentage (xGF %), High Danger Chances For Percentage (HDCF %), High Danger Shots For Percentage (HDSF %), and PDO, which can be downloaded from repositories, or acquired by real-time input.

In one embodiment, there can be an emphasis on forwards' Expected Goals For Percentage (xGF %) and defensemen's Corsi For Percentage (CF %). These statistics provide a granular look at individual contributions, allowing for nuanced analysis of player impact on game outcomes.

Goalie statistics, particularly Goals Saved Above Average (GSAA), can be sourced from a repository or analytical hub, offering insights into a goaltender's performance relative to league averages-a key factor in predicting game results.

For real-time updates on player injuries, the processor can access websites or databases acquiring real-time data from an on-going game. A real-time data source can be instrumental in adjusting predictions based on the latest health status of key players, ensuring the model accounts for their potential impact-or absence-in upcoming games.

Recent game wins, a vital indicator of team momentum and form can provide a snapshot of team performance trends, contributing to the predictive accuracy of the system.

Lastly, data on back-to-back game scenarios, which can significantly affect team performance due to fatigue, can also be retrieved from websites, databases or repositories of this data. Recognizing the importance of such scheduling nuances, this information is integrated into the model to refine outcome predictions further.

In essence, the outcome prediction system 102 leverages these varied data sources to compile a comprehensive dataset that includes team dynamics, individual player performance, goaltender efficacy, current form, and injury impacts. By drawing from these well-regarded and reliable sources, the system ensures its predictive models are both accurate and reflective of the complex nature of sports competitions.

In at least one embodiment, team statistics can include metrics that reflect the performance of a team as a whole. Team statistics can include metrics such as total goals scored, total goals conceded, total shots on goal, possession percentage, pass completion rate, and number of wins, losses, and draws.

In at least one embodiment, player statistics can include metrics that reflect the performance of individual players. Player statistics can include metrics such as goals scored, assists, shots on goal, pass completion rate, tackles, interceptions, blocks, and distance covered.

In at least one embodiment, goalie statistics can include metrics that reflect the performance of a team's goal-keeper. Goalie statistics can include metrics such as saves made, goals conceded, clean sheets (games without conceding a goal), save percentage, and distribution accuracy.

In at least one embodiment, recent win statistics can include metrics that reflect a team's performance in recent matches, particularly in terms of wins. Recent win statistics can include metrics such as number of wins in the last 5 or 10 matches, win percentage in the last 5 or 10 matches, and average goals scored and conceded in those matches.

In at least one embodiment, player injury statistics can include metrics that track player injuries, such as the number of injuries, type of injuries, severity of injuries, and time missed due to injuries. Player injury statistics can also include metrics related to recovery time and injury recurrence.

The data can be sourced in real-time, or near real-time to provide reliable predictions. In some embodiments, the data can be sourced at a given frequency, such as hourly, daily, weekly, monthly, etc. In some embodiments, the data can be sourced after every game is completed, or while a game is on-going.

Once the data is sourced, the data can be stored in the central data bank 312. In at least one embodiment, the data stored in the central bank 312 can also be over-written with updated or new data whenever a change to the dataset occurs. In at least one embodiment, the data can be manually changed to reflect any changes to the dataset. The central databank 312 can form a part of the external data storage 108 or the storage component 110 shown in FIG. 1. In at least one embodiment, the data can be stored as a CSV files, key value pairs, row/column store, JSON, XML, Parquet, or any other suitable format. CSV files stores data in a plain text format, where each line represents a row of data, and each value within a row is separated by a comma; Key-value pairs store data as a collection of key-value mappings, where each key is unique and corresponds to a single value; Row stores store data in rows, where each row contains all the columns for a single record. Column stores store data in columns, where each column contains all the values for a particular attribute across all records; JSON stores data as text in a human-readable format, using key-value pairs and arrays to represent structured data; XML stores data as text in a hierarchical structure, using tags to define elements and attributes to provide additional information about elements; and Parquet stores data in a columnar format, where data for each column is stored together, allowing for efficient reading of specific columns without loading entire rows.

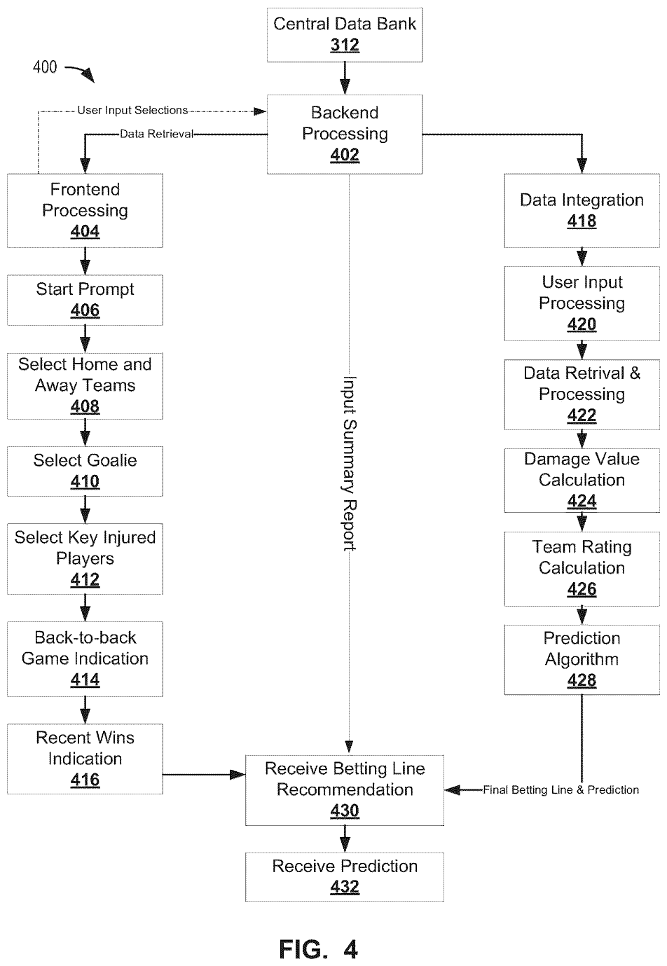

Referring now to FIG. 4, there is shown a process flow diagram of an example method of predicting an outcome of an event determined by the outcome prediction system 102. Once the data is stored in the central databank 312, the processor can retrieve the data for backend processing at 402. In at least one embodiment, the process flow can begin by the user accessing the outcome prediction system 102 by a user device 106, over a network 104. In at least one embodiment, users can initialize by picking two teams, such as in the NHL®, MLB®, NFL® or any other team league.

Once the user initializes the team selection, goalies can be suggested. Optionally, the user can have the flexibility to make their own goalie selection. In one embodiment, injured players can be automatically suggested by the platform, but users can optionally override the automated suggestion based on their knowledge and personal opinions.

As such, the user can be prompted, at 406, by the outcome prediction system 102 to enter information regarding the prediction the user is searching for. In at least one embodiment, the user can be prompted to enter information such as home and away teams for a game at 408, select the goalie or goal-keeper for both the away team and the home team at 410; and select injured players for both teams at 412. In at least one embodiment, the goalie being selected can be selected from a drop down list of goalies currently on the roster of the team. In at least one embodiment, the system 102 can obtain the data in real time by pulling the information from a live data source.

In one embodiment, recent game wins statistics 307, sourced from the data bank 312, can be automatically factored into the prediction model. This pre-populated data recognizes the momentum and psychological advantages that recent victories can confer upon a team. The user can also be prompted to enter an indication whether the team is playing a game on consecutive days i.e. a “back to back game” at 414. In at least one embodiment, the back-to-back game indication information may already be pre-populated by the system 102. The user can further be prompted to enter an indication whether the team has had any recent wins (i.e. such as wins for the last 5 games) at 416. In at least one embodiment, the recent wins information may already be pre-populated by the system 102.

The user input selections can be input into the backend processing at 402, along with the data from the central databank 312. The data can be integrated into the system 102 by processor 112 at the data integration step 418. The user input selections can also be processed at the backend at step 420. The data and the processed user inputs can be retrieved into the system 102 by processor 112 at the data integration step 422. At step 422, the retrieved data can also be further processed. Once the data is obtained, the processor 112 can be configured to calculate a damage value at 424 and calculate a team rating at 426. The damage value calculations, team rating calculations and optionally, the user input selections, and recent wins and consecutive game indications can be used by the processor in a prediction algorithm 428. The prediction algorithm 428 can be configured to use the damage value calculations, team rating calculations and optionally, the user input selections, and recent wins and consecutive game indications to output an outcome. In at least one embodiment, the outcome can comprise a betting line recommendation 430 and/or a prediction 432.

The betting line recommendation 430 refers to a specific guidance generated by the outcome prediction system 102, aimed at guiding users towards making informed betting decisions based on the calculated probabilities of game outcomes. This recommendation leverages the comprehensive analysis provided by the prediction algorithm 428, which includes damage value calculations, team rating calculations, and, when applicable, user input selections alongside recent wins and considerations for consecutive games. The system, through its nuanced understanding of these variables, can recommend betting lines such as Money Line, −1.5, or −2.5 for scenarios where the predicted winning team has a high probability percentage (≥x %). Conversely, for instances where a lower probability percentage (≤x %) is calculated, especially in contexts where the underdog team is predicted to win, the system advises on betting lines favoring the underdog, such as Money Line, +1.5, or +2.5. This dual-path recommendation approach ensures that users are provided with tailored betting strategies that align with the nuanced probabilities determined by the system, optimizing their potential for favourable outcomes in sports betting endeavors.

The prediction 432 refers to the outcome forecast of a sporting event, intricately linked with and directly informing the betting line recommendation 430. The prediction 432, therefore, forms the cornerstone of the outcome prediction system 102's functionality, providing a robust forecast about the outcome of a sporting event. This forecast underpins the betting line recommendation 430, with the two components working in unison to furnish users with both a predictive insight into the game's likely result and a guided strategy for betting based on those insights. The system's algorithm 428 meticulously evaluates a host of inputs-including damage value calculations, team and player ratings, and recent win statistics-to forge a prediction that is as comprehensive as it is precise. The subsequent translation of this prediction into a betting line recommendation underscores the system's capacity to serve not merely as a predictive tool but as an integrated solution for informed betting strategy formulation, bridging the gap between predictive analytics and practical betting application.

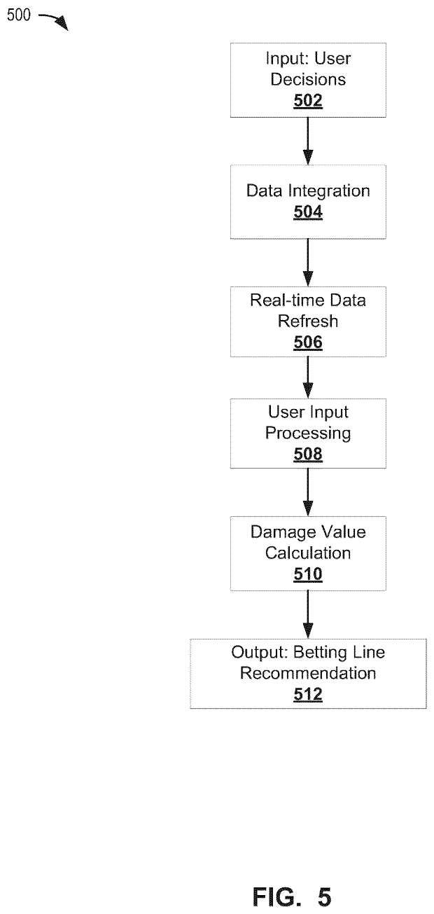

Referring now to FIG. 5, there is shown a process flow diagram of an example method of predicting an outcome of an event determined by the outcome prediction system 102. In at least one embodiment, user decisions 502 can be input into the outcome prediction system 102. In at least one embodiment, user decisions 502 can include decisions such as, but not limited to: starting goalie selection, home team selection, away team selection, injured player selection, starting lineup, and any other user-decisions that may be used by the processor to predict an outcome, and as previously described in reference to FIG. 4. In at least one embodiment, the user decisions at 502 can be integrated with the data in the central databank 312.

In at least one embodiment, and as illustrated in step 506, the retrieved data can be refreshed or updated in real-time to obtain the most accurate prediction. The data, along with the user inputs can be processed at 508. Once the data is obtained, the processor 112 can be configured to calculate a damage value at 510. In at least one embodiment, the damage value calculations and optionally, the user input selections, and recent wins and consecutive game indications can be used by the processor in a prediction algorithm 428. The prediction algorithm 428 can be configured to use the damage value calculations and optionally, the user input selections, and recent wins and consecutive game indications to output an outcome 512.

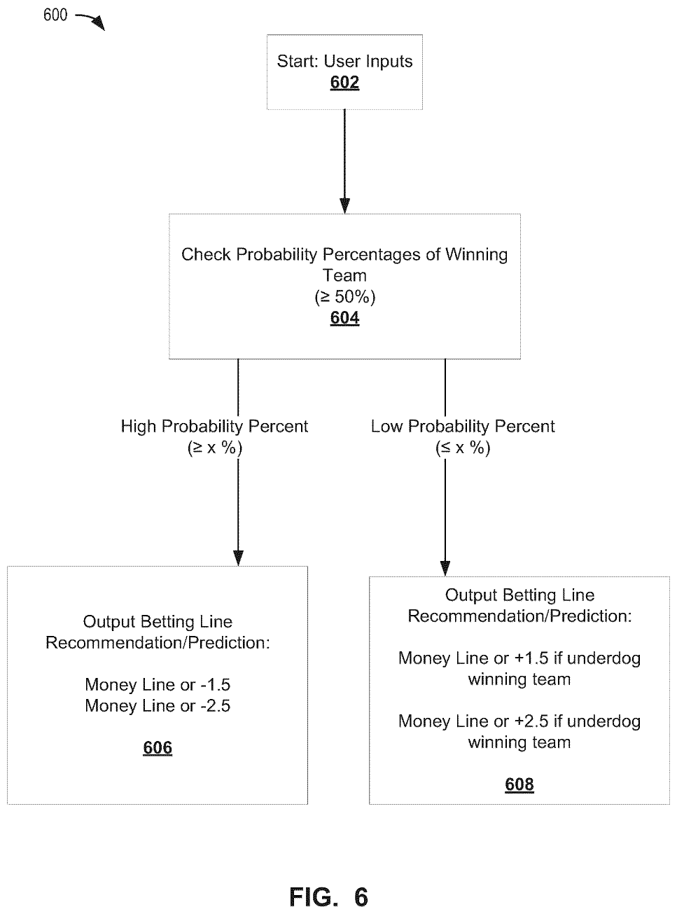

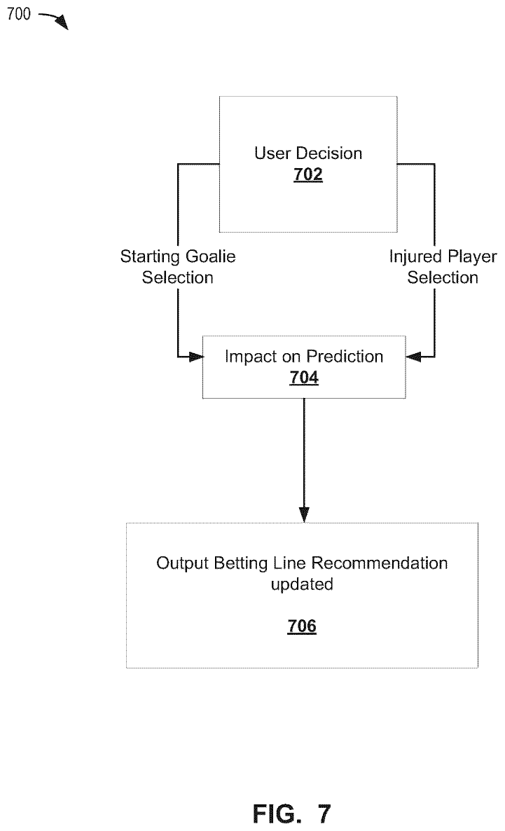

Referring now to FIGS. 6 and 7, there is shown a process flow diagram of an example method used by the outcome prediction system 102. Data can be dynamically pulled based on user interactions. The system can be configured to calculate a damage value that quantifies the impact of injuries on team performance. In at least one embodiment, the processor can be configured to calculate a damage value at 424 and calculate a team rating at 426. In at least one embodiment, the processor can use any suitable method to calculate the damage value and team rating. In at least one embodiment, the processor can use an implied probabilities formula to calculate the damage value and team rating. The damage factor can refer to a factor or multiplier that is proportional to the number of injured players on the team. The damage factor can impact the probability of any given team winning a game, such as lowering the probability or in some cases, increasing the probability. In at least one embodiment, the damage factor can be proportional to factors such as recent losses, away team disadvantage, playing of consecutive games, roster of players, player statistics, team statistics, goalie statistics, and player injuries.

In at least one embodiment, an advantage factor can be calculated which can be proportional to factors such as recent wins, home team advantage, lack of consecutive games, roster of players, player statistics, team statistics, goalie statistics, and lack of injuries. In at least one embodiment, the damage factor can be inversely related to the advantage factor. In at least one embodiment, weightings can be given or assigned to each of these factors to calculate the damage factor or advantage factor. As shown in FIG. 7, the user decision 702 can impact the prediction as the starting goalie selection and the injured player selection can affect the damage factor and/or the advantage factor. As such, the betting line recommendation or the prediction 706 may have to be updated as the user decisions are updated.

In at least one embodiment, the system leverages several key statistics with predetermined weightages to influence the predictions, including but not limited to: CF % (Corsi For Percentage): Measures shot attempt differentials, a predictor of team possession and performance; xGA (Expected Goals Against) and xGF % (Expected Goals For Percentage): Predict the goals a team is expected to score and concede, providing insight into offensive and defensive prowess; HDCF % and HDSF %: Focus on high-danger scoring chances and shots, respectively, assessing a team's ability to create clear-cut opportunities; PDO: A measure of shooting plus save percentage, often used as a proxy for luck; GSAA (Goals Saved Above Average): Measures a goalie's performance compared to the league average; xGF % for forwards and xCF % for defensemen: Used to assess the performance of individual key injured players in offensive and defensive roles. The combination of these statistics, other data points, and user inputs drives the prediction algorithm to produce the match outcome probability.

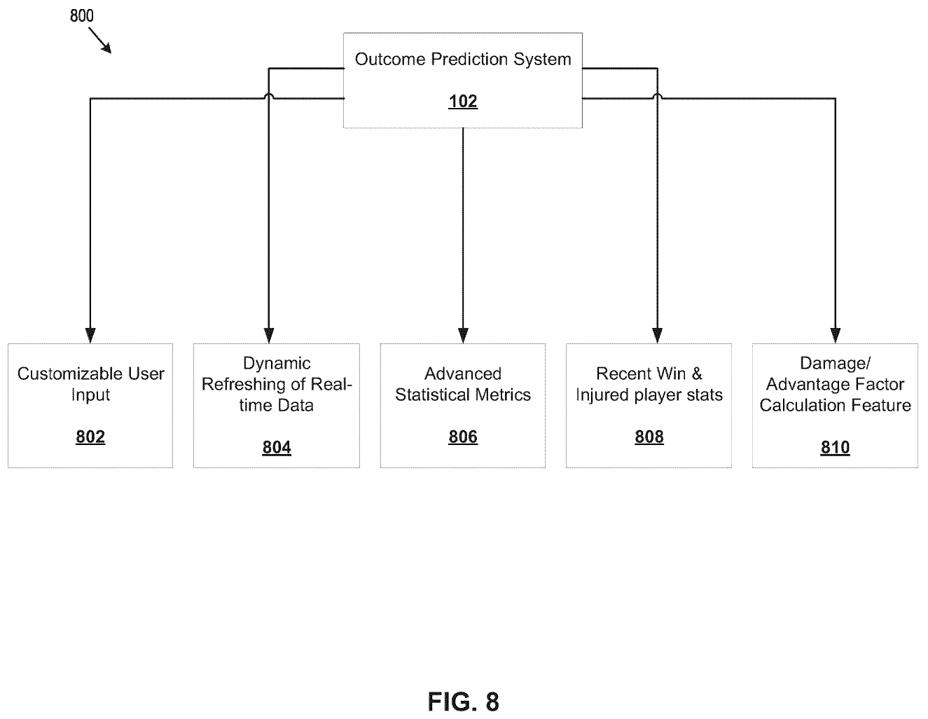

Referring now to FIG. 8, there is shown a process flow diagram of example inputs into outcome prediction system 102. The output prediction system 102 features a customizable user input 802, automatic updating to the dataset in real-time 804, configuring the processor to use advanced metrics and statistics 806, inputting or retrieving recent win and injured player statistics 808, and a damage factor calculation feature 810. The processor 112 can be configured to use the features shown in FIG. 8 to determine or calculate a predicted outcome.

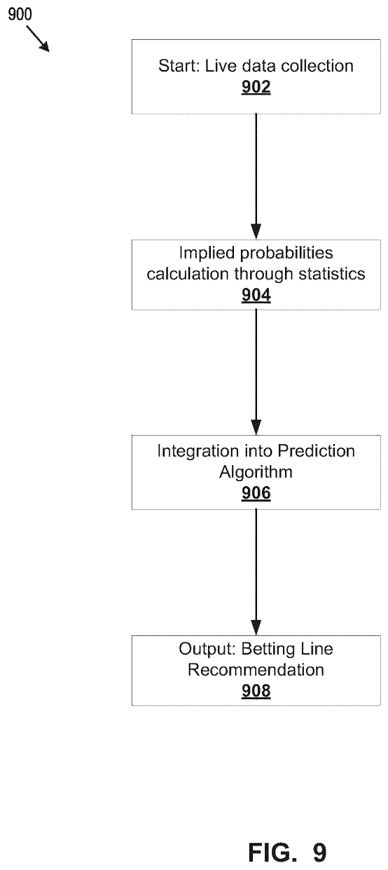

Referring now to FIG. 9, there is shown is a process flow diagram of an example method of predicting an outcome of an event determined by the outcome prediction system 102. In at least one embodiment, the processor is configured to obtain the live data at 902. Using the collected data, the processor 112 is configured to calculate or determine an implied probabilities calculation. The calculation can then be input into a prediction algorithm 906 to output a prediction outcome at 908.

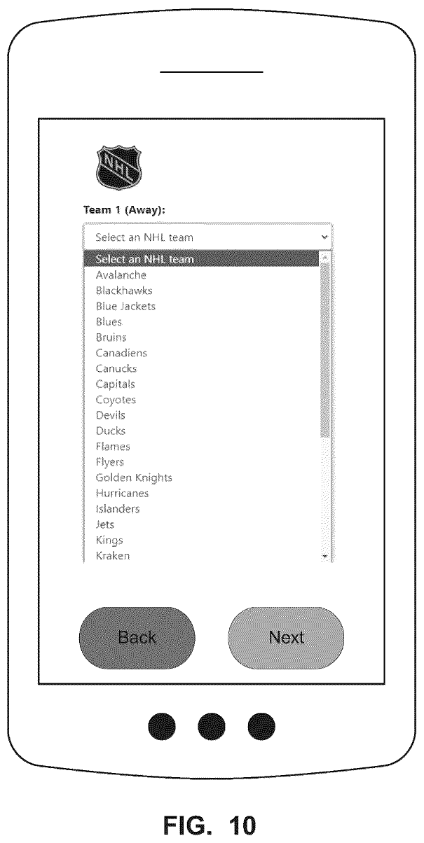

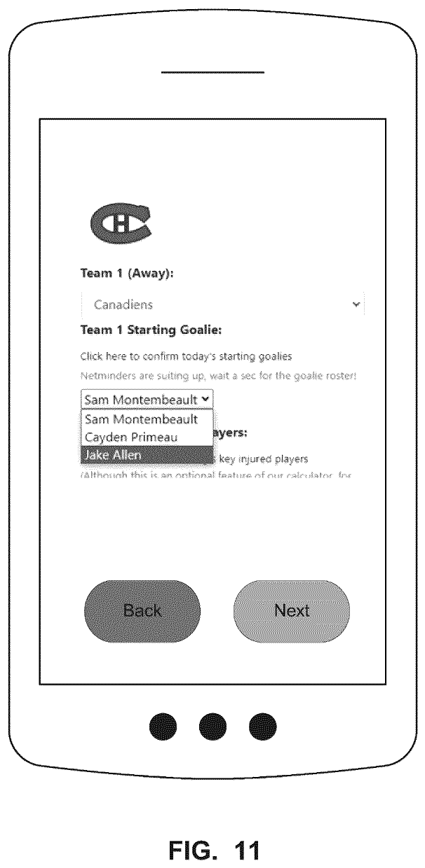

Referring now to FIGS. 10 to 18, there is shown is an example GUI showing the step-by-step user interface selections of the outcome prediction system 102 on a user device 106 in accordance with an embodiment. In at least one embodiment, and as shown in FIG. 10, users can initialize by picking a first away team from teams in a given league, including but not limited to: the NHL®, MLB®, NFL® or any other team league. The available options can be provided in a drop-down list where the user can select the team. Once the user initializes the away team selection, away goalies can be suggested, as shown in FIG. 11. The suggested away goalies can be associated with, or in the roster of the selected away team. Optionally, the user can have the flexibility to make their own goalie selection. This feature is particularly invaluable during live games when unexpected events, such as a goalie change due to injury or poor performance, necessitate swift adjustments to predictions. By empowering users with the ability to select or change goalies based on real-time developments, the system significantly enhances the accuracy and relevance of its predictions, ensuring that users have access to the most current and strategic insights possible.

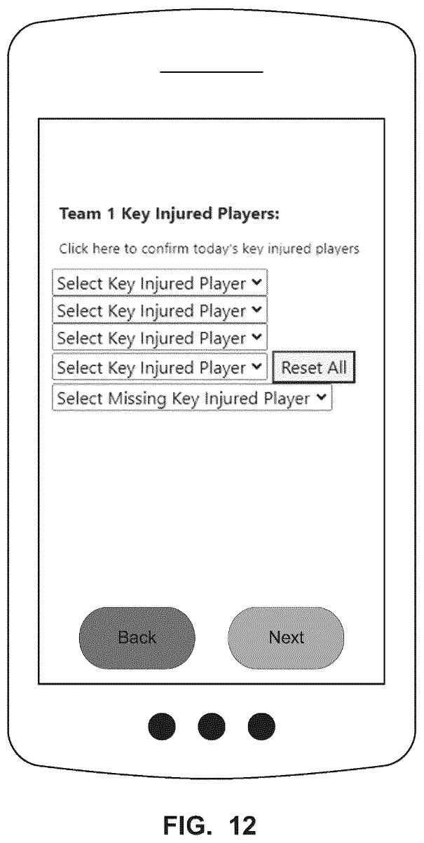

Turning now to FIG. 12, and in at least one embodiment, users can input any injured players on the away team. In at least one embodiment, injured players can be automatically suggested by the system 102, but users can optionally override the automated suggestion based on their knowledge and personal opinions.

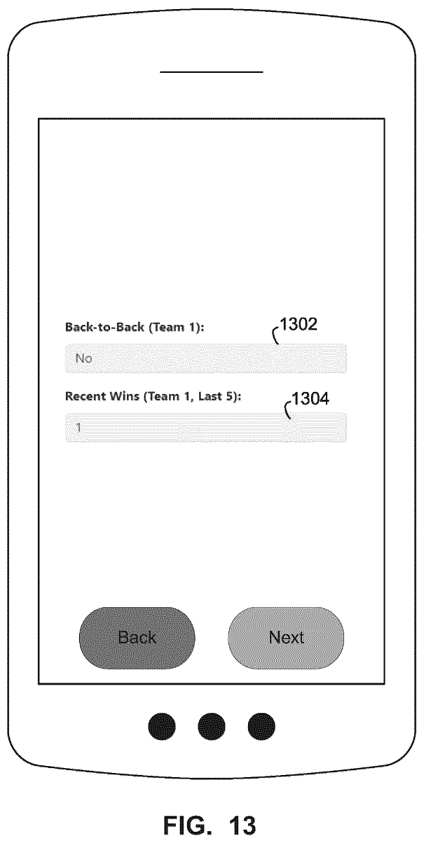

Turning now to FIG. 13, and in at least one embodiment, users can input or review recent game wins statistics at 1304 for the away team. In one embodiment, the recent game wins statistics can be sourced from the data bank, and can be automatically factored into the prediction model. The user can also be prompted to enter an indication whether the away team is playing a game on consecutive days i.e. a “back to back game” at 1302. In at least one embodiment, the back-to-back game indication information may already be pre-populated by the system 102. The user can further be prompted to enter an indication whether the away team has had any recent wins (i.e. such as wins for the last 5 games) to 1304. In at least one embodiment, the recent wins information may already be pre-populated by the system 102.

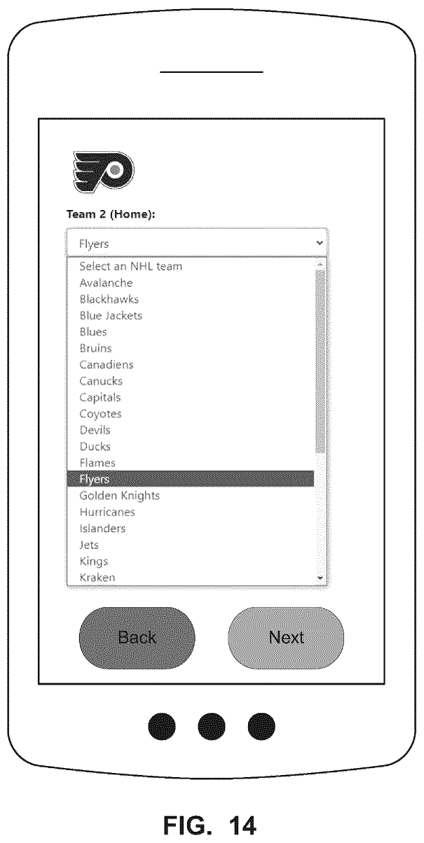

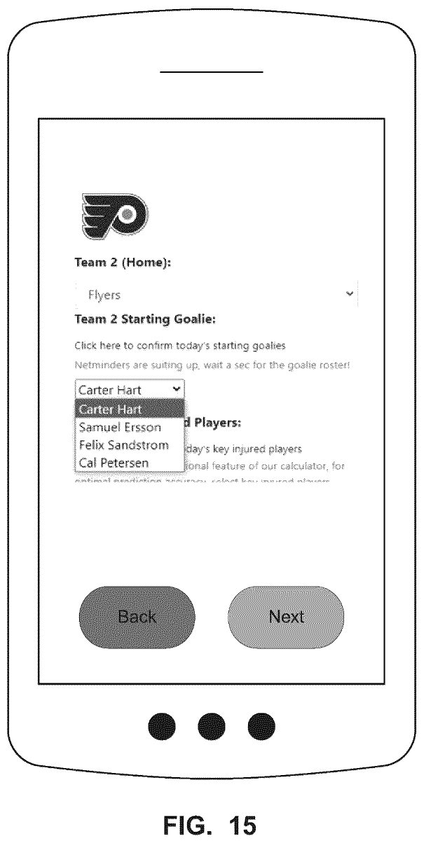

Turning now to FIG. 14, and in at least one embodiment, users can input or select the home team. Once the user selects the home team, home goalies associated with the selected home team can be suggested, as shown in FIG. 15. Optionally, the user can have the flexibility to make their own goalie selection.

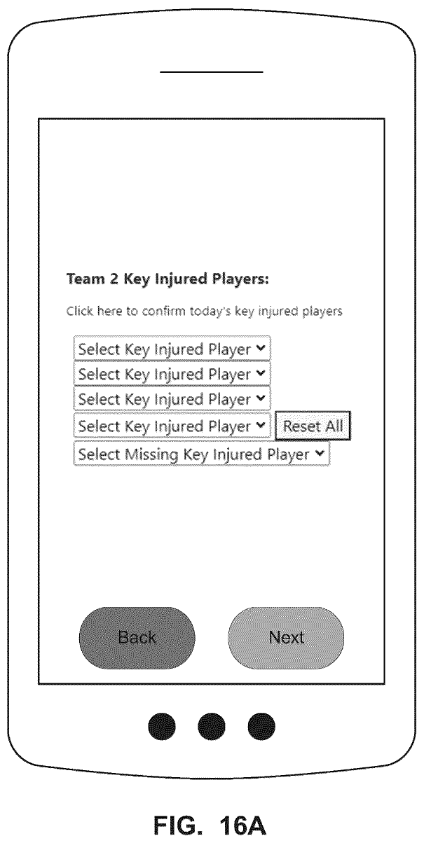

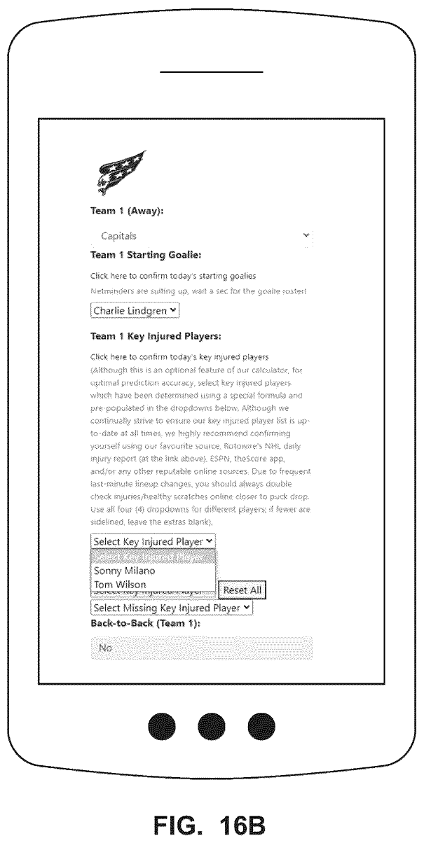

Turning now to FIG. 16A, and in at least one embodiment, users can input any injured players on the home team. In at least one embodiment, injured players can be automatically suggested by the system 102, but users can optionally override the automated suggestion based on their knowledge and personal opinions. An example of the injured player selection is shown in FIG. 16B.

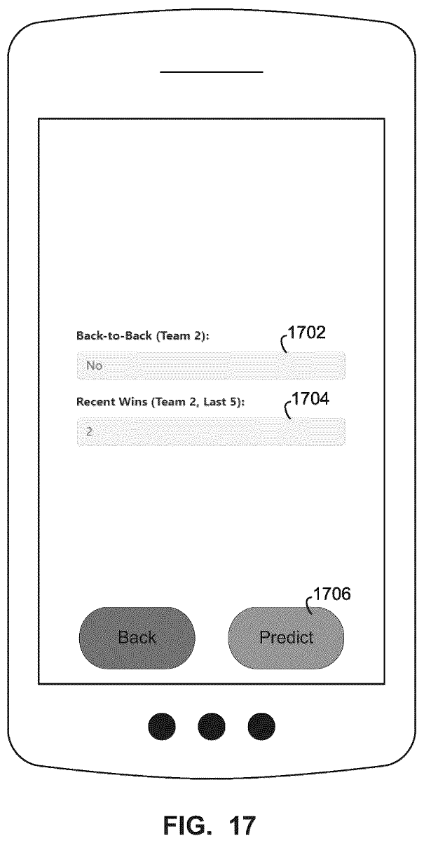

Turning now to FIG. 17, and in at least one embodiment, users can input or review recent game wins statistics for the home team at 1704. In one embodiment, the recent game wins statistics can be sourced from the data bank, and can be automatically factored into the prediction model. The user can also be prompted to enter an indication whether the home team is playing a game on consecutive days i.e. a “back to back game” at 1702. In at least one embodiment, the back-to-back game indication information may already be pre-populated by the system 102. The user can further be prompted to enter an indication whether the home team has had any recent wins (i.e. such as wins for the last 5 games) to 1704. In at least one embodiment, the recent wins information may already be pre-populated by the system 102. Once all of the user selections has been entered, the user may proceed with the prediction by selecting “predict” at 1706.

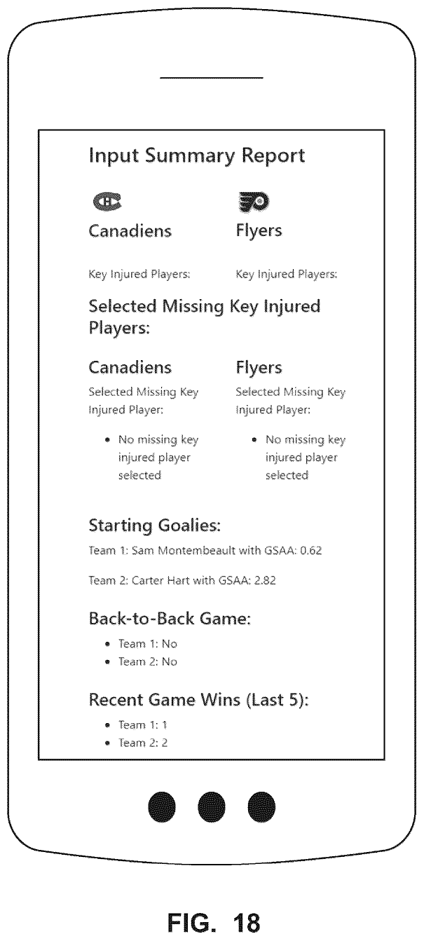

Turning now to FIG. 18, and in at least one embodiment, an input summary report can be provided to the user displaying, on a user device, and summarizing the user selections for the prediction. The system 102 can transmit this information, along with the data obtained from the data bank to the processor 112. The processor 112 can use this information, along with the data obtained from the data bank to calculate or determine an outcome prediction and betting line recommendation based on the user-selected inputs such as home team, away team, starting goalies, injured players, recent wins and consecutive games.

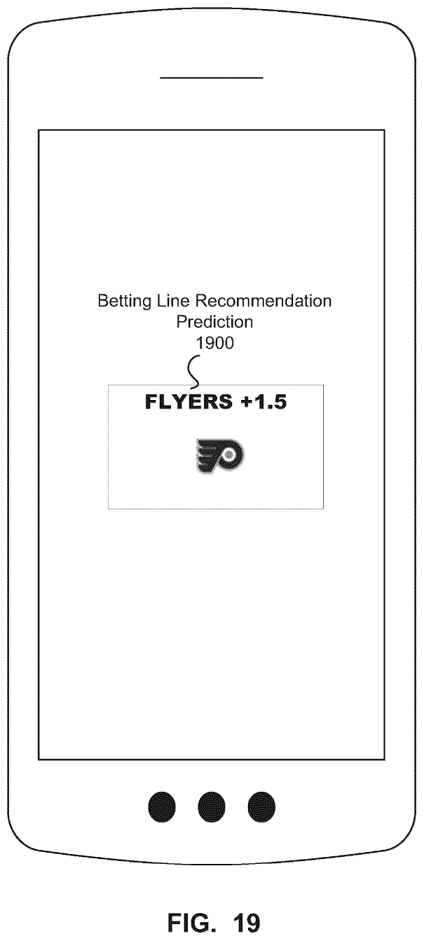

Turning now to FIG. 19, and in at least one embodiment, a betting line recommendation or prediction can be provided to the user displaying, on a user device, the prediction. The system 102 can calculate or determine an outcome prediction and betting line recommendation 1900 based on the user-selected inputs such as home team, away team, starting goalies, injured players, recent wins and consecutive games.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A system for predicting an outcome of a sporting event, comprising:
a database for storing a plurality of data related to the sporting event;
a processor in communication with the database, the processor operable to:
receive a prediction request, wherein each prediction request comprises a home team selection, and an away team selection relating to the sporting event;
for each prediction request,
determine one or more damage factors relating to the chosen home team and away team;
calculate an implied probability score based on the damage factors for the chosen home team and away team;
determine an outcome prediction and a betting line recommendation based on the implied probability score; and
transmit the outcome prediction and the betting line recommendation to a user device associated with the prediction request,
wherein the outcome prediction comprises an indication of the home team or the away team winning the sporting event; and
wherein the betting line recommendation comprises odds of the home team or the away team winning the sporting event.

2. The system of claim 1, wherein the processor is further operable to: receive an consecutive game indication indicating that the sporting event is being played consecutively by a home team or an away team.

3. The system of any one of claim 1 or 2, wherein the processor is further operable to: receive an recent wins indication indicating that at least one of the home team and the away team has recently won at least one of a plurality of past sporting events.

4. The system of any one of claims 1 to 3, wherein the plurality of data comprises at least one of: team statistics, player statistics, goalie statistics, recent win statistics, and player injury statistics.

5. The system of any one of claims 1 to 4, wherein the database is sourced in real-time, or near real-time.

6. The system of any one of claims 1 to 5, wherein the database is updated at least one of: hourly, daily, weekly, monthly, once the sporting event is completed, and as the sporting event is on-going.

7. The system of claim 4, wherein the data is stored as at least one of: CSV files, key value pairs, row/column store, JSON, XML, and Parquet files.

8. The system of claims 1 to 7, wherein calculating an implied probability score based on the damage factors for the chosen home team and away team comprises leveraging at least one of a plurality of statistics with predetermined weightages to influence the outcome prediction.

9. The system of any one of claims 1 to 8, wherein the plurality of statistics comprises at least one of: CF % (Corsi For Percentage); xGA (Expected Goals Against) and xGF % (Expected Goals For Percentage); HDCF % and HDSF %; PDO; GSAA (Goals Saved Above Average); and xGF % for forwards and xCF % for defensemen.

10. The system of any one of claims 1 to 9, wherein the damage factor is proportional to at least one of: recent losses, away team disadvantage, playing of consecutive games, roster of players, player statistics, team statistics, goalie statistics, and player injuries.

11. The system of any one of claims 1 to 10, wherein the processor is further operable to determine one or more advantage factors relating to the chosen home team and away team.

12. The system of claim 11, wherein the advantage factor is proportional to at least one of: recent wins, home team advantage, lack of consecutive games, roster of players, player statistics, team statistics, goalie statistics, and lack of injuries.

13. The system of any one of claim 11 or 12, wherein the damage factor can be inversely related to the advantage factor.

14. A method for predicting an outcome of a sporting event, the method comprising the steps of:
storing a plurality of data related to the sporting event in a database;
receiving, by a processor, a prediction request, wherein each prediction request comprises a home team selection, and an away team selection relating to the sporting event;
for each prediction request,
determining, by the processor, one or more damage factors relating to the chosen home team and away team;
calculating, by the processor, an implied probability score based on the damage factors for the chosen home team and away team;
determining, by the processor, an outcome prediction and a betting line recommendation based on the implied probability score; and
transmitting, by the processor, the outcome prediction and the betting line recommendation to a user device associated with the prediction request,
wherein the outcome prediction comprises an indication of the home team or the away team winning the sporting event; and
wherein the betting line recommendation comprises odds of the home team or the away team winning the sporting event.

15. The method of claim 11, further comprising updating the database in real-time, or near real-time.

16. The method of claim 11, further comprising updating the database least one of: hourly, daily, weekly, monthly, once the sporting event is completed, and as the sporting event is on-going.

17. The method of any one of claims 11 to 13, further comprising calculating an implied probability score based on the damage factors for the chosen home team and away team comprises leveraging at least one of a plurality of statistics with predetermined weightages to influence the outcome prediction.

18. The method of claim 15, wherein the plurality of statistics comprises at least one of: CF % (Corsi For Percentage); xGA (Expected Goals Against) and xGF % (Expected Goals For Percentage); HDCF % and HDSF %; PDO; GSAA (Goals Saved Above Average); and xGF % for forwards and xCF % for defensemen.

19. The method of claim 15, wherein the damage factor is proportional to at least one of: recent losses, away team disadvantage, playing of consecutive games, roster of players, player statistics, team statistics, goalie statistics, and player injuries.

20. The method of claim 15, further comprising, determining, by the processor, one or more advantage factors relating to the chosen home team and away team.

21. The method of claim 15, wherein the advantage factor is proportional to at least one of: recent wins, home team advantage, lack of consecutive games, roster of players, player statistics, team statistics, goalie statistics, and lack of injuries.
